(19) United States
(12) Patent Application Publication
(10) Pub. No.: US 2025/0361352 A1
(43) Pub. Date: Nov. 27, 2025

(54) COMPOSITION FOR FLEXIBLE POLYURETHANE FOAM, FLEXIBLE POLYURETHANE FOAM, AND AUTOMOTIVE SEAT PAD

(71) Applicant: Archem Inc., Minato-ku, Tokyo (JP)

(72) Inventors: Koji SANEFUJI, Minato-ku, Tokyo (JP); Hideharu SEGUCHI, Minato-ku, Tokyo (JP); Naoko NISIKITA, Minato-ku, Tokyo (JP); Yuki ADACHI, Minato-ku, Tokyo (JP)

(73) Assignee: Archem Inc., Minato-ku, Tokyo (JP)

(21) Appl. No.: 18/871,586

(22) PCT Filed: Jun. 7, 2023
(86) PCT No.: PCT/JP2023/021241

§ 371 Date: Dec. 4, 2024

(30) Foreign Application Priority Data
Jul. 25, 2022 (JP) 2022-118267

(51) Int. Cl. C08G 18/18; C08G 18/20; C08G 18/48

(52) U.S. Cl. CPC C08G 18/1825; C08G 18/2063; C08G 18/4804; C08G 2110/0008

(57) ABSTRACT

A composition for a flexible polyurethane foam that enables manufacturing of a flexible polyurethane foam with reduced odor and excellent curability is provided. The composition for a flexible polyurethane foam contains a polyether polyol (A), a reactive amine catalyst (B) with one or more amino groups and one or more hydroxyl groups, a non-reactive amine catalyst (C) with one or more amino groups and no hydroxyl group, and a silicone foam stabilizer (D), wherein, when the total amount of polyol components without amino groups is considered to be 100 parts by mass, the content of the reactive amine catalyst (B) is 0.01 to 1.3 parts by mass, the non-reactive amine catalyst (C) is 0.01 to 0.20 parts by mass, the silicone foam stabilizer (D) is 0.2 to 1.5 parts by mass, and the silicone foam stabilizer (D) contains two types of silicones (D1 and D2) with different surface tensions.

### TECHNICAL FIELD

The present disclosure relates to a composition for a flexible polyurethane foam, a flexible polyurethane foam, and an automotive seat pad.

### BACKGROUND

Flexible polyurethane foams are widely used in seat pads for automobiles, etc., due to their excellent cushioning properties. In the meantime, various studies have been conducted on flexible polyurethane foams to improve their properties such as impact absorption.

However, due to the raw materials used in the manufacturing process, flexible polyurethane foams can emit odors that spread inside vehicles or rooms, negatively affecting comfort performance. In addressing this issue, for example, PTL 1 discloses the production of polyurethane foams that comprehensively suppress the generation of VOCs such as amines and styrene, which cause unpleasant odors, by optimizing raw materials such as polyols as a composition for manufacturing flexible polyurethane foams and by using reactive amine catalysts.

### CITATION LIST

### Patent Literature

PTL 1: WO2020/004123 A1 SUMMARY

### Technical Problem

However, odor-suppressing technology tends to result in residual deformation when a load is applied (for example, during demolding from the mold), namely, inadequate curability. Longer reaction times within the mold are required to impart the required curability, leading to a decrease in productivity. Thus, the above-mentioned conventional composition still has room for improvement in terms of increasing curability while reducing odor when manufacturing flexible polyurethane foams.

Therefore, the present disclosure is directed to providing a composition for a flexible polyurethane foam that enables the manufacturing of a flexible polyurethane foam with reduced odor and excellent curability.

Additionally, the present disclosure is directed to providing a flexible polyurethane foam with reduced odor and excellent curability, as well as an automotive seat pad including such a flexible polyurethane foam.

### Solution to Problem

The main features of the present disclosure for solving the above problem are as follows.

[1] A composition for a flexible polyurethane foam comprising:
a polyether polyol (A);
a reactive amine catalyst (B) that is a compound having one or more amino groups and one or more hydroxyl groups;
a non-reactive amine catalyst (C) that is a compound having one or more amino groups and no hydroxyl group; and
a silicone foam stabilizer (D),
wherein, when a total amount of polyol components without amino groups is considered to be 100 parts by mass, a content of the reactive amine catalyst (B) is 0.01 parts by mass or more and 1.3 parts by mass or less, a content of the non-reactive amine catalyst (C) is 0.01 parts by mass or more and 0.20 parts by mass or less, and a content of the silicone foam stabilizer (D) is 0.2 parts by mass or more and 1.5 parts by mass or less, and
the silicone foam stabilizer (D) comprises a silicone (D1) with a surface tension of 22 mN/m or more, and a silicone (D2) with a surface tension of less than 22 mN/m, measured by the capillary rise method.

[2] The composition for a flexible polyurethane foam according to [1], further comprising water (E), wherein, when the total amount of polyol components without amino groups is considered to be 100 parts by mass, a content of water (E) is 2 parts by mass or more and 5 parts by mass or less.

[3] The composition for a flexible polyurethane foam according to [1] or [2], wherein the polyether polyol (A) comprises a polyether polyol with a weight average molecular weight of 6,000 or more.

[4] A flexible polyurethane foam obtained by mixing the composition for a flexible polyurethane foam according to any one of [1] to [3] with a polyisocyanate, followed by foaming.

[5] The flexible polyurethane foam according to [4], wherein a core density measured according to JIS K7222 is 30 kg/m³ or more and 75 kg/m³ or less.

[6] An automotive seat pad comprising the flexible polyurethane foam according to [4] or [5].

### Advantageous Effect

According to the present disclosure, it is possible to provide a composition for a flexible polyurethane foam that enables manufacturing of a flexible polyurethane foam with reduced odor and excellent curability.

Additionally, according to the present disclosure, it is possible to provide a flexible polyurethane foam with reduced odor and excellent curability, as well as an automotive seat pad including such a flexible polyurethane foam.

### DETAILED DESCRIPTION

In the following, the present disclosure will be described in detail based on an embodiment thereof.

The compounds described in this specification may partially or entirely be derived from fossil resources, biological resources such as plant-based materials, or recycled resources such as used tires. Additionally, they may be derived from a mixture of two or more of fossil resources, biological resources, and recycled resources.

### (Composition for Flexible Polyurethane Foam)

The composition for a flexible polyurethane foam of one embodiment of the present disclosure (hereinafter, sometimes referred to as “the composition of the present embodiment”) contains a polyether polyol (A), a reactive amine catalyst (B) that is a compound having one or more amino groups and one or more hydroxyl groups, a non-reactive amine catalyst (C) that is a compound having one or more amino groups and no hydroxyl group, and a silicone foam stabilizer (D). In the composition of the present embodiment, when the total amount of polyol components without amino groups is considered to be 100 parts by mass, the content of the reactive amine catalyst (B) is 0.01 parts by mass or more and 1.3 parts by mass or less, the content of the non-reactive amine catalyst (C) is 0.01 parts by mass or more and 0.20 parts by mass or less, and the content of the silicone foam stabilizer (D) is 0.2 parts by mass or more and 1.5 parts by mass or less. Furthermore, the silicone foam stabilizer (D) contains a silicone (D1) with a surface tension of 22 mN/m or more, and a silicone (D2) with a surface tension of less than 22 mN/m, measured by the capillary rise method.

In this specification, substituted amino groups are also regarded as “amino groups”.

Conventionally, amine catalysts other than reactive amine catalysts (specifically, non-reactive amine catalysts) are typically volatile and one of the causes of odors. However, it has been found that by using the reactive amine catalyst (B) together with the non-reactive amine catalyst ((C) component) in the composition of the present embodiment, and setting the content of the reactive amine catalyst (B) to 0.01 parts by mass or more and 1.3 parts by mass or less and the content of the non-reactive amine catalyst (C) to 0.05 parts by mass or more and 0.73 parts by mass or less, when the total amount of polyol components without amino groups is considered to be 100 parts by mass, significant odor reduction can be achieved even if the non-reactive amine catalyst is included.

Furthermore, with the composition of the present embodiment, a high curability can be achieved by containing the non-reactive amine catalyst (C) in a predetermined amount, and, the reactivity or fluidity during the reaction between polyol and polyisocyanate is enhanced by using the two specific components in predetermined amounts in the silicone foam stabilizer (D). Additionally, when injected into a mold, it can spread throughout the mold before the urethanization reaction fully begins. As a result, even when injected into a mold with a complex shape, a polyurethane foam can be obtained without defects. Improved fluidity contributes to uniform reaction promotion of the polyurethane foam and, consequently, also improves curability.

Therefore, by using the composition of the present embodiment, a flexible polyurethane foam with reduced odor and excellent curability can be produced.

The following is a detailed description of each component that may be contained in the composition of the present embodiment.

In this specification, the content of each component such as the reactive amine catalyst (B), non-reactive amine catalyst (C), silicone foam stabilizer (D), etc., in the composition is, in principle, indicated as a percentage relative to the “total amount of polyol components without amino groups,” with this total considered to be 100 parts by mass. The “polyol components without amino groups” typically correspond to the polyether polyol (A), but may also include polyol components other than the polyether polyol (A), such as polyhydric alcohols (e.g., glycerin) or crosslinking agents that are polyol components.

<Polyether Polyol (a)>

The composition of the present embodiment contains a polyether polyol as the (A) component. Here, a polyether polyol generally refers to a polyoxyalkylene polyol obtained by ring-opening addition polymerization of an alkylene oxide with an initiator having two or more active hydrogen atoms. The polyether polyols (A) may be used alone or in combination with two or more types.

It is preferable that the polyether polyol (A) used in the present embodiment includes a polyether polyol with a weight average molecular weight of 6,000 or more. In this case, it is possible to improve the riding comfort performance, particularly cushioning properties.

The weight average molecular weight of the polyether polyol (A) used in the present embodiment is preferably in the range of 3,000 or more and 12,000 or less. This allows for balancing hardness, rebound elasticity, stress relaxation, and curability of the polyurethane foam. From a similar viewpoint, the weight average molecular weight of the polyether polyol (A) is more preferably 4,500 or more and 11,000 or less, and even more preferably 4,800 or more and 10,000 or less.

When adding the polyether polyol (A) to the composition, the polyether polyol may be used as it is or a polymer polyol (generally, one in which organic particles are dispersed in a polyether polyol) may be used. Specifically, the composition of the present embodiment may include a polyether polyol alone, polymer polyol (generally, one in which organic particles are dispersed in a polyether polyol) alone, or a combination of the polyether polyol and the polymer polyol as described above, as the (A) component. The polyether polyol contained in such a polymer polyol is also considered as the (A) component. In particular, it is preferable to use at least a polymer polyol, and more preferable to use a combination of a polyether polyol and a polymer polyol. This can also be viewed from a different viewpoint: the composition of the present embodiment preferably contains 6 parts by mass or more and 18 parts by mass or less of organic particles per 100 parts by mass of total polyol components without amino groups. When in the above range, both the defoaming effect and maintaining hardness can be achieved.

The organic particles are not particularly limited but examples include organic particles of copolymers of acrylonitrile and styrene, homopolymers of acrylonitrile, and homopolymers of styrene.

### <Reactive Amine Catalyst (B)>

The composition of the present embodiment contains a reactive amine catalyst as the component (B). Here, a reactive amine catalyst is a compound that has one or more amino groups and one or more hydroxyl groups (OH groups).

Examples of the reactive amine catalyst (B) include amine catalysts, such as monoethanolamine, diethanolamine, triethanolamine, dimethylethanolamine (DMEA), N,N,N′-trimethylaminoethylethanolamine, N,N-dimethylaminoethoxyethanol, N,N-dimethylaminohexanol, N,N-dimethylaminoethoxyhexanol, 2-[(2-[2-(dimethylamino)ethoxy]ethyl)methylamino]ethanol, 2-[[3-(dimethylamino)propyl]methylamino]ethanol, 1,1′-[[3-(dimethylamino)propyl]imino]bis-2-propanol, and 2-hydroxymethyl-triethylenediamine. The reactive amine catalyst (B) may be used alone or in combination with two or more types. Among these, it is preferable to use 2-[(2-[2-(dimethylamino)ethoxy]ethyl)methylamino]ethanol as the reactive amine catalyst (B).

The content of the reactive amine catalyst (B) in the composition of the present embodiment is 0.01 parts by mass or more and 1.3 parts by mass or less, when the total amount of polyol components without amino groups is considered to be 100 parts by mass. If the content is less than 0.01 parts by mass, the odor reduction effect in a flexible urethane foam may not be sufficiently achieved. If the content exceeds 1.3 parts by mass, the curability of the flexible urethane foam may be reduced, and disadvantages in terms of cost may arise. From a similar viewpoint, the content of the reactive amine catalyst (B) is more preferably 0.03 parts by mass or more, and even more preferably 0.05 parts by mass or more, and preferably 0.63 parts by mass or less, and more preferably 0.58 parts by mass or less.

### <Non-reactive Amine Catalyst (C)>

The composition of the present embodiment contains a non-reactive amine catalyst as the component (C). Here, a non-reactive amine catalyst (C) is a compound that has one or more amino groups and no hydroxyl group (OH group).

Examples of the non-reactive amine catalyst (C) include amine catalysts, such as triethylamine, tripropylamine, tributylamine, hexadecyl dimethylamine, N-methylmorpholine, N-ethylmorpholine, N-octadecylmorpholine, diethyltriamine, N,N,N′,N′-tetramethylhexanediamine, N,N,N′,N′-tetramethylpropanediamine, N,N,N′,N″,N″-pentamethyldiethylenetriamine, N,N′,N′-trimethylaminoethylpiperazine, N,N-dimethylcyclohexylamine, N,N,N′,N′-tetramethylethylenediamine, and triethylenediamine. The non-reactive amine catalyst (C) may be used alone or in combination with two or more types. Among these, it is preferable to use triethylenediamine as the non-reactive amine catalyst (C).

The content of the non-reactive amine catalyst (C) in the composition of the present embodiment is 0.01 parts by mass or more and 0.20 parts by mass or less, when the total amount of polyol components without amino groups is considered to be 100 parts by mass. If the content is less than 0.01 parts by mass, the curability of the flexible polyurethane foam may be reduced. If the content exceeds 0.20 parts by mass, the odor from the flexible polyurethane foam may become strong, negatively affecting comfort performance inside vehicles or rooms. From a similar viewpoint, the content of the non-reactive amine catalyst (C) is more preferably 0.025 parts by mass or more, and even more preferably 0.04 parts by mass or more, and even more preferably 0.06 parts by mass or more, and preferably 0.196 parts by mass or less, and even more preferably 0.192 parts by mass or less.

In the composition of the present embodiment, the mass ratio of the content of the reactive amine catalyst (B) to the content of the non-reactive amine catalyst (C) ((B)/(C)) is preferably 0.09 or more and 8.0 or less. This ensures an even better balance between the reduction of odor and the improvement of curability.

### <Silicone Foam Stabilizer (D)>

The composition of the present embodiment contains a silicone foam stabilizer as the (D) component. A silicone foam stabilizer refers to a compound containing silicon, specifically a siloxane bond, and exhibits foam-stabilizing effects during the manufacturing of a flexible polyurethane foam. In the composition of the present embodiment, the (D) component includes a silicone (D1) with a surface tension of 22 mN/m or more and a silicone (D2) with a surface tension of less than 22 mN/m, measured by the capillary rise method. The silicone (D1) and the silicone (D2) can each be used alone or in combination with two or more types.

The content (total content) of the silicone foam stabilizer (D) in the composition of the present embodiment is 0.2 parts by mass or more and 1.5 parts by mass or less, when the total amount of polyol components without amino groups is considered to be 100 parts by mass. During the manufacturing of urethane foams, it is important to maintain a balance between the resinification reaction and the foaming reaction. If the content is less than 0.2 parts by mass, the surface tension necessary for the foaming reaction is not sufficiently imparted in the system, which may result in coarse cells and the reduction in tactile properties in the final urethane foam. Additionally, if the content is less than 0.2 parts by mass, the foam may not be produced and lead to defective formation. On the other hand, if the content exceeds 1.5 parts by mass, the independent cell ratio in the urethane foam may become too high, causing cracks (punctures) in the foam because the air inside cannot be escaped during the defoaming process. From a similar viewpoint, the content of the silicone foam stabilizer (D) is preferably 0.3 parts by mass or more, and more preferably 0.9 parts by mass or less.

### <Water (E)>

The composition of the present embodiment preferably contains water as the component (E). Water reacts with the polyisocyanate to generate carbon dioxide gas, acting as a blowing agent during the manufacturing of a flexible polyurethane foam. The content of water (E) in the composition of the present embodiment is preferably 2 parts by mass or more and 5 parts by mass or less, when the total amount of polyol components without amino groups is considered to be 100 parts by mass. In this case, good seating comfort and riding comfort can be ensured. The density of the urethane foam can be controlled by adjusting the amount of water to a predetermined amount, and the reaction promoting effect (specifically, the effect of promoting the reaction that forms urea bonds, and the effect of promoting the overall reaction system, including the urethanization reaction, by the heat generated by the progression of the urea bond formation reaction) can be expected. From a similar viewpoint, the content of water (E) is more preferably 2.1 parts by mass or more, even more preferably 2.2 parts by mass or more, and more preferably 4.7 parts by mass or less, even more preferably 4.5 parts by mass or less, and further preferably 4.4 parts by mass or less, when the total amount of polyol components without amino groups is considered to be 100 parts by mass.

### <Other Components>

In addition to the components (A) to (E) mentioned above, the composition of the present embodiment may also contain other components as needed. Examples of other components include polyol components other than the polyether polyol (A) (such as polyhydric alcohols and polyester polyols); catalysts other than the reactive amine catalyst (B) and the non-reactive amine catalyst (C); and foam stabilizers other than the silicone foam stabilizer (D); and blowing agents other than water (E). Polyhydric alcohols such as ethylene glycol, 1,3-propanediol, 1,4-butanediol, and glycerin may be mentioned as examples of the above polyhydric alcohols.

However, it is preferable that the composition of the present embodiment does not contain polyester polyols, from the viewpoint of obtaining the desired performances as a flexible polyurethane foam. This is because, for example, in applications such as automotive seats, which are expected to be used for years, polyester polyols that are susceptible to hydrolysis may cause adverse effects.

It is also preferable that the composition of the present embodiment substantially does not contain catalysts other than the reactive amine catalyst (B) and the non-reactive amine catalyst (C), from the viewpoint of obtaining the desired performances as a flexible polyurethane foam. For example, it is preferable that the composition of the present embodiment does not contain metal-based catalysts, such as tin, to obtain a urethane foam that is more environmentally friendly. Furthermore, catalysts with higher catalytic activity than those of amine-based catalysts used in the present embodiment may excessively increase the independent cell ratio during the foaming reaction, potentially leading to the deformation of the urethane foam.

### (Flexible Polyurethane Foam)

The flexible polyurethane foam of one embodiment of the present disclosure (hereinafter referred to as “the flexible polyurethane foam of the present embodiment”) is obtained by mixing the composition for a flexible polyurethane foam as described above with a polyisocyanate, followed by foaming. Since such a flexible polyurethane foam of the present embodiment is obtained using the composition as described above, it has reduced odor and excellent curability.

A “flexible polyurethane foam” refers to a polyurethane foam with continuous cells and resilience under load.

Examples of the polyisocyanate include tolylene diisocyanate (TDI), diphenylmethane diisocyanate (MDI), dicyclohexylmethane diisocyanate, triphenyl diisocyanate, xylylene diisocyanate, polymethylene polyphenylene polyisocyanate, methylene diisocyanate, hexamethylene diisocyanate, isophorone diisocyanate, ortho-toluidine diisocyanate, naphthylene diisocyanate, xylylene diisocyanate, lysine diisocyanate, and derivatives thereof. Polyisocyanates can be used alone or in combination with two or more types. Particularly, in view of the density of the resulting flexible polyurethane foam, it is preferable to use only MDI or a combination of TDI and MDI. When TDI and MDI are used in combination, the ratio of the TDI:MDI (mass ratio) is preferably between 70:30 and 90:10.

The amount of the polyisocyanate used, represented as the number of isocyanate groups per 100 times the total number of active hydrogen atoms in polyether polyol, water, and the like (this value is referred to as the isocyanate index), is preferably 80 or more and 120 or less. If the isocyanate index is 80 or more, the shrinkage defects of the resulting flexible polyurethane foam can be sufficiently suppressed. The collapse of the foam can be sufficiently suppressed if the index is 120 or less. From a similar viewpoint, the isocyanate index is more preferably 95 or more, and more preferably 115 or less.

The flexible polyurethane foam of the present embodiment can be obtained by mold forming. Specifically, in this method, the composition for a flexible polyurethane foam as described above, and the polyisocyanate are first mixed to prepare a foaming solution. Next, a flexible polyurethane foam can be obtained by injecting the foaming solution into the cavity of a mold and performing mold forming (foaming) according to a conventional method at a temperature of 50 to 65° C. and a curing time of 5 to 7 minutes.

After molding, the flexible polyurethane foam can be subjected to crushing treatment using rollers or the like. Crushing treatment is a process that breaks the cell membranes of cells formed during foaming to connect the cells, aiming to stabilize the shape of the foam and suppress shrinkage.

The core density of the flexible polyurethane foam of the present embodiment, measured according to JIS K7222, is preferably 30 kg/m³ or more and 75 kg/m³ or less. This ensures good seating comfort and riding comfort. The core density can be adjusted by changing the amount of the blowing agent in the composition for a flexible polyurethane foam. A flexible polyurethane foam with a core density of 30 to 45 kg/m³ is particularly preferred for use as a back pad placed at the back. On the other hand, a flexible polyurethane foam with a core density of more than 45 to 75 kg/m³ is particularly preferred for use as a cushion pad placed on the seat surface.

### (Automotive Seat Pad)

The automotive seat pad of one embodiment of the present disclosure (hereinafter referred to as “the seat pad of the present embodiment”) includes the flexible polyurethane foam as described above. Since the seat pad of the present embodiment is manufactured using the polyurethane foam as described above, it has reduced odor and excellent curability.

### EXAMPLES

In the following, the present disclosure will be described in detail further with reference to examples. However, these examples are intended for illustration only and are not intended to limit the present disclosure in any way. In Tables 1 and 2, the contents of the component (C) are listed up to the third decimal place, the contents of the components (B) and (D) are listed up to the second decimal place, and the contents of the components (A) and (E) are listed up to the first decimal place.

The compositions for a flexible polyurethane foam were prepared according to a conventional method based on the formulations summarized in Tables 1 and 2. Note that, in the formulations, “polyol components without amino groups” refer to polyether polyols and polyether polyols contained in polymer polyols.

Next, flexible polyurethane foams were manufactured by mixing the resulting compositions for a flexible polyurethane foam with polyisocyanate (“CORONATE® 1021”, manufactured by Tosoh Corporation) to obtain an isocyanate index of 100, and performing mold forming (foaming). In Comparative Examples 1 and 2 and Example 1, the amount of water, which acts as a blowing agent, was adjusted to obtain a core density (measured according to JIS K7222) of 38 kg/m³ for the resulting flexible polyurethane foams. In Comparative Examples 3 and 4 and Example 2, the amount of water was adjusted to obtain a core density of 50 kg/m³.

### (Evaluation of Odor)

For the resulting flexible polyurethane foam of each example, six samples of 10 cm×10 cm×20 mm in thickness were prepared and the odor was evaluated (odor intensity, hedonic scale, and odor over time) according to TSM 0505G. The evaluation results of the odor intensity and hedonic scale of Comparative Examples 1, 2, and Example 1 are summarized in Table 1, and the evaluation results of the odor over time of Comparative Examples 3, 4, and Example 2 are summarized in Table 2. In all cases, smaller values indicate reduced odor.

### (Evaluation of Curability)

The hardness of the flexible polyurethane foam at the time of demolding was measured for each example after mold forming. The measurement values of Comparative Example 1 were set to 100 and used as the index for Comparative Examples 1, 2, and Example 1. Similarly, the measurement values of Comparative Example 3 were set to 100 and used as the index for Comparative Examples 3, 4, and Example 2. The results are summarized in Tables 1 and 2. Higher values indicate better curability.

TABLE 1

| | | | Comparative | Comparative | |
|---|---|---|---|---|---|
| | | | Example 1 | Example 2 | Example 1 |
| (A) | Polyether polyol *1 | parts by mass | 85.8 | 85.8 | 85.8 |
| | Polymer polyol *2 | parts by mass *11 | 14.2 | 14.2 | 14.2 |
| | Total | parts by mass | 100.0 | 100.0 | 100.0 |
| (B) | Reactive amine catalyst 1*3 | parts by mass | 0.21 | 0.21 | 0.21 |
| | Reactive amine catalyst 2 (25 to 40%) *4 | | 0 | 0.54 | 0 |
| | Reactive amine catalyst 3 *5 | | 0 | 0.32 | 0.32 |
| | Total (amount equivalent to component (B)) | | 0.21 | 0.67~0.75 | 0.54 |
| (C) | Non-reactive amine catalyst 1 (33%) *6 | parts by mass | 0.268 | 0 | 0.268 |
| | Non-reactive amine catalyst 2 (23%) *7 | | 0.536 | 0 | 0 |
| | Total (amount equivalent to component (C)) | | 0.212 | 0.000 | 0.089 |
| (D) | Silicone foam stabilizer 2-1 *8 | parts by mass | 0 | 0.27 | 0.27 |
| | Silicone foam stabilizer 2-2 *9 | | 0.27 | 0 | 0 |
| | Silicone foam stabilizer 1 *10 | | 0.43 | 0.43 | 0.43 |
| | Total | | 0.70 | 0.70 | 0.70 |
| (E) | Water | parts by mass | 4.4 | 4.4 | 4.4 |

| Amount equivalent to component (B)/amount equivalent to component (C) | | 1.0 | | 6.1 |
|---|---|---|---|---|
| Odor | Odor intensity | 100 | 95 | 95 |
| | Hedonic scale | −0.5 | −0.4 | −0.4 |

| | | | |
|---|---|---|---|
| Curability | 100 | 92 | 106 |

TABLE 2

| | | | Comparative | Comparative | |
|---|---|---|---|---|---|
| | | | Example 3 | Example 4 | Example 2 |
| (A) | Polyether polyol *1 | parts by mass | 69.4 | 69.4 | 69.4 |
| | Polymer polyol *2 | parts by mass *11 | 30.6 | 30.6 | 30.6 |
| | Total | parts by mass | 100.0 | 100.0 | 100.0 |
| (B) | Reactive amine catalyst 1*3 | parts by mass | 0 | 0 | 0 |
| | Reactive amine catalyst 2 (25 to 40%) *4 | | 0 | 1.16 | 0 |
| | Reactive amine catalyst 3 *5 | | 0 | 0.12 | 0.12 |
| | Total (amount equivalent to component (B)) | | 0.00 | 0.41~0.58 | 0.12 |
| (C) | Non-reactive amine catalyst 1 (33%) *6 | parts by mass | 0.579 | 0 | 0.579 |
| | Non-reactive amine catalyst 2 (23%) *7 | | 0.347 | 0 | 0 |
| | Total (amount equivalent to component (C)) | | 0.271 | 0.000 | 0.191 |
| (D) | Silicone foam stabilizer 2-1 *8 | parts by mass | 0 | 0.35 | 0.35 |
| | Silicone foam stabilizer 2-2 *9 | | 0.35 | 0 | 0 |
| | Silicone foam stabilizer 1 *10 | | 0.17 | 0.17 | 0.17 |
| | Total | | 0.52 | 0.52 | 0.52 |
| (E) | Water | parts by mass | 3.6 | 3.6 | 3.6 |

| Amount equivalent to component (B)/amount equivalent to component (C) | | 0 | | 0.6 |
|---|---|---|---|---|
| Odor | Odor over time | 100 | 94 | 94 |

| | | | |
|---|---|---|---|
| Curability | 100 | 83 | 101 |

*1: Polyether polyol: “SPECFLEX NC632 Polyol DA,” manufactured by Dow Chemical, weight average molecular weight: 7,000
*2: Polymer polyol: “SANNIX KC-863,” manufactured by Sanyo Chemical Industries Ltd., weight average molecular weight of polyether polyol contained: 5,400
*3: Reactive amine catalyst 1: diethanolamine manufactured by Nippon Shokubai Co., Ltd.
*4: Reactive amine catalyst 2: “RZETA-HD,” manufactured by Tosoh Corporation, containing 25 to 40 mass % of a structure having triethylenediamine as the main skeleton and containing hydroxyl groups
*5: Reactive amine catalyst 3: “JEFFCAT ZF10,” manufactured by Huntsman Corporation, 2-[[2-[2-(dimethylamino)ethoxy]ethyl]methylamino]ethanol
*6: Non-reactive amine catalyst 1: “DABCO 33LV,” manufactured by Evonik, containing 33 mass % of triethylenediamine
*7: Non-reactive amine catalyst 2: “TOYOCAT-ET33B,” manufactured by Tosoh Corporation, containing 23 mass % of bis(2-dimethylaminoethyl)ether
*8: Silicone foam stabilizer 2-1: “Niax Silicone L-3628J,” manufactured by Momentive Performance Materials Japan LLC, surface tension: 21 mN/m (estimated value)
*9: Silicone foam stabilizer 2-2: “Niax Silicone L-3627J,” manufactured by Momentive Performance Materials Japan LLC, surface tension: 21 mN/m
*10: Silicone foam stabilizer 1: “Niax Silicone L-3647J,” manufactured by Momentive Performance Materials Japan LLC, surface tension: 23 mN/m
*11: It indicates polyether polyol (contained in the polymer polyol) in parts by mass. (The amounts of organic particles (contained in the polymer polyol) were 7.3 parts by mass in Comparative Examples 1, 2, and Example 1, and the amounts of the organic particles (contained in the polymer polyol) were 15.7 parts by mass Comparative Examples 3, 4, and Example 2.)

It can be seen from Tables 1 and 2 that the flexible polyurethane foams in the examples had reduced odor and excellent curability.

In particular, as disclosed in this specification, the formulations with relatively low densities, such as that in Example 1 in Table 1, exhibited greater effects in reducing odor intensity and hedonic scale, while the formulations with relatively high densities, such as that in Example 2 in Table 2, exhibited greater effects in reducing odor over time.

### INDUSTRIAL APPLICABILITY

According to the present disclosure, it is possible to provide a composition for a flexible polyurethane foam that enables manufacturing of a flexible polyurethane foam with reduced odor and excellent curability.

Additionally, according to the present disclosure, it is possible to provide a flexible polyurethane foam with reduced odor and excellent curability, as well as an automotive seat pad including such a flexible polyurethane foam.

1. A composition for a flexible polyurethane foam comprising:
a polyether polyol (A);
a reactive amine catalyst (B) that is a compound having one or more amino groups and one or more hydroxyl groups;
a non-reactive amine catalyst (C) that is a compound having one or more amino groups and no hydroxyl group; and
a silicone foam stabilizer (D),
wherein, when a total amount of polyol components without amino groups is considered to be 100 parts by mass, a content of the reactive amine catalyst (B) is 0.01 parts by mass or more and 1.3 parts by mass or less, a content of the non-reactive amine catalyst (C) is 0.01 parts by mass or more and 0.20 parts by mass or less, and a content of the silicone foam stabilizer (D) is 0.2 parts by mass or more and 1.5 parts by mass or less, and
the silicone foam stabilizer (D) comprises a silicone (D1) with a surface tension of 22 mN/m or more, and a silicone (D2) with a surface tension of less than 22 mN/m, measured by the capillary rise method.

2. The composition for a flexible polyurethane foam according to claim 1, further comprising water (E), wherein, when the total amount of polyol components without amino groups is considered to be 100 parts by mass, a content of water (E) is 2 parts by mass or more and 5 parts by mass or less.

3. The composition for a flexible polyurethane foam according to claim 1, wherein the polyether polyol (A) comprises a polyether polyol with a weight average molecular weight of 6,000 or more.

4. A flexible polyurethane foam obtained by mixing the composition for a flexible polyurethane foam according to claim 1 with a polyisocyanate, followed by foaming.

5. The flexible polyurethane foam according to claim 4, wherein a core density measured according to JIS K7222 is 35 kg/m³ or more and 75 kg/m³ or less.

6. An automotive seat pad comprising the flexible polyurethane foam according to claim 4.

7. The composition for a flexible polyurethane foam according to claim 2, wherein the polyether polyol (A) comprises a polyether polyol with a weight average molecular weight of 6,000 or more.

8. A flexible polyurethane foam obtained by mixing the composition for a flexible polyurethane foam according to claim 2 with a polyisocyanate, followed by foaming.

9. The flexible polyurethane foam according to claim 8, wherein a core density measured according to JIS K7222 is 35 kg/m³ or more and 75 kg/m³ or less.

10. An automotive seat pad comprising the flexible polyurethane foam according to claim 8.

11. A flexible polyurethane foam obtained by mixing the composition for a flexible polyurethane foam according to claim 3 with a polyisocyanate, followed by foaming.

12. The flexible polyurethane foam according to claim 11, wherein a core density measured according to JIS K7222 is 35 kg/m³ or more and 75 kg/m³ or less.

13. An automotive seat pad comprising the flexible polyurethane foam according to claim 11.

14. A flexible polyurethane foam obtained by mixing the composition for a flexible polyurethane foam according to claim 7 with a polyisocyanate, followed by foaming.

15. The flexible polyurethane foam according to claim 14, wherein a core density measured according to JIS K7222 is 35 kg/m³ or more and 75 kg/m³ or less.

16. An automotive seat pad comprising the flexible polyurethane foam according to claim 14.

17. An automotive seat pad comprising the flexible polyurethane foam according to claim 5.

18. An automotive seat pad comprising the flexible polyurethane foam according to claim 9.

19. An automotive seat pad comprising the flexible polyurethane foam according to claim 12.

20. An automotive seat pad comprising the flexible polyurethane foam according to claim 15.
